(19) United States
(12) Patent Application Publication
(10) Pub. No.: US 2013/0339840 A1
(43) Pub. Date: Dec. 19, 2013

(54) SYSTEM AND METHOD FOR LOGICAL CHUNKING AND RESTRUCTURING WEBSITES

(71) Applicants: Anand Jain, Ellicotte City, MD (US); Vishal Grover, Belle Mead, NJ (US)

(72) Inventors: Anand Jain, Ellicotte City, MD (US); Vishal Grover, Belle Mead, NJ (US)

(21) Appl. No.: 13/887,656

(22) Filed: May 6, 2013

Related U.S. Application Data
(60) Provisional application No. 61/688,083, filed on May 8, 2012.

(51) Int. Cl. G06F 17/22

(52) U.S. Cl. CPC G06F 17/2247
USPC 715/234

(57) ABSTRACT

The present invention provides significantly improved accessibility of website content on mobile and tablet devices with an emphasis on preserving the original intent of the content author/designer by inferring the characteristics of navigability, content organization and chunking and then adapting the original content for multiple end user device profiles using a rule based techniques. Aspects of the present invention address issues with information searching, navigation constraints of the devices, the content organization, information clutter and information overload on web pages and adapting the content to leverage device specific features by generating extensible user interface widget code.

The present application claims priority from U.S. Provisional Application No. 61/688,083, filed May 8, 2012, the entire disclosure of which is incorporated herein by reference.

### BACKGROUND

The present invention generally relates to viewing website content.

As the mobile and tablet device proliferation continues in the information age, accessibility and usability of all types of content/information on these devices is considered extremely important. The sophistication of mobile infrastructure around the globe is fragmented and is evolving at a different pace in the different parts of the globe. So is the evolution and adoptions of these on-the-go/mobile and tablet devices. This device fragmentation (feature/size & sophistication) and platform fragmentation is making content presentation very difficult to manage for the content providers. Generic, extensible solutions are required for content presentation on different mobile and tablet devices as the device fragmentation continues.

A conventional system for viewing web content will be described with reference to FIG. 1.

FIG. 1 shows conventional system 100, which illustrates various end user devices accessing webpages from a web server via the internet.

As shown in the figure, conventional system 100 includes a web server 102, a Personal Computer (PC) 108, a tablet 112, a smartphone 118 and a budget cellphone 122.

In the figure, PC 108 is arranged to access webpages on web server 102 via an internet signal 110, an internet/cellular infrastructure 106 and an internet signal 104. Tablet 112 is arranged to access webpages on web server 102 via an internet signal 114, internet/cellular infrastructure 106 and internet signal 104. Smartphone 118 is arranged to access webpages on web server 102 via an internet signal 120, internet/cellular infrastructure 106 and internet signal 104. Budget cellphone 122 is arranged to access webpages on web server 102 via an internet signal 124, internet/cellular infrastructure 106 and internet signal 104.

Web server 102, Personal Computer (PC) 108, tablet 112, smartphone 118 and budget cellphone 122 provide the conventional functionality of a web server, a PC, a smartphone and a budget cellphone respectively. Web server 102 hosts webpages designed to be viewed and navigated by an end user using a computer with a conventional computer monitor or laptop screen, a conventional keyboard and a conventional mouse. PC 108 has the functionality and user interfaces for which the webpages hosted by web server 102 are targeted. Tablet 112 provides conventional tablet or pad user interfaces such as a touch screen which has a somewhat smaller viewing area than a PC and a “soft” QWERTY keyboard accessed via the touch screen. Smartphone 118 provides conventional smartphone user interfaces such as a touch screen which is considerably smaller than those of a PC or a tablet, a “soft” QWERTY keyboard accessed via the touch screen and a “soft” keyboard accessed via the touch screen. Smartphone 118 may or may not also contain a miniature “hard” keyboard and a trackball, track wheel or track pad. Budget cellphone 122 provides conventional budget cellphone user interfaces such as a read-only screen or a touch screen which is the smallest screen of all the considered end user devices, a “hard” numeric-only keyboard, “hard” control buttons and, if equipped with a touch screen, some “soft” control buttons.

The webpages made accessible by web server 102 are conventional webpages designed to be viewed on a personal computer monitor. All four device types, PC 108, tablet 112, smartphone 118 and budget cellphone 122 are able to access the webpages stored on web server 102.

Of these, only the user of PC 108 is able to view and navigate the webpages in the manner and with the ease intended by the webpage designers. The user of PC 108 can view the entire area of the webpage intended by the designers, can read the text easily, can see all the different sections of the page intended by the designers including, as is convention, a main menu for website navigation, the main body of the webpage, subsections of the page, any branding or third party content and so on. In addition, the user of PC 108 can navigate the entire webpage by use of a conventional mouse.

Compared to PC 108, the other end user devices, tablet 112, smartphone 118 and budget telephone 122, each to a different extent, have fewer features, smaller screens, smaller physical user interfaces and other attributes which create many difficulties in viewing and navigating webpages designed for a larger screen. Conventional difficulties include truncated viewing areas, small type sizes, information clutter, constant changing of screen resolutions and webpage positions to bring sections into view horizontally and vertically, sections not in view being missed, user input typing difficulties, and navigation issues.

What is needed is a way to create and present a new set of webpages from information contained in an original PC-targeted webpage, the new set of webpages being tailored to the properties of smaller end user devices, such as mobile phones and tablets, to significantly improve the ease of viewing and navigation while still preserving the original intent of the webpage designers.

### BRIEF SUMMARY

The present invention provides a system and method of breaking down the information contained in the PC-targeted webpages into logical chunks as perceived by humans. The present invention additionally provides a system and method of creating and presenting a new set of webpages from information contained in an original PC-targeted webpage, wherein the new set of webpages being tailored to the properties of smaller end user devices, such as mobile phones and tablets, to significantly improve the ease of viewing and navigation while still preserving the original intents of the webpage designers.

An aspect of the present invention provides a webpage document analyzer, a logical chunk identifying component, a TOC generating component, a code generator and a communications block to access original webpages from a server, to analyze the structure of the webpages and the information contained in them and to infer from the analysis various chunks, chunk types and properties of the original webpage as they would be perceived by a human. Another aspect of the invention produces data structures, or chunks, which represent the various logical sections of a webpage and presents them as widgets for viewing by various mobile and tablet user devices according to the device's features and properties. Another aspect of the invention produces a Table of Contents (TOC), the entries in which represents each chunk and provides access to the information contained in the chunks by a mobile or tablet user. A further aspect of the invention is drawn to adapting the content for display on various classes of mobile device.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 shows a conventional system which illustrates various end user devices accessing webpages from a web server via the internet;

FIG. 2 shows a conventional system enhanced with webpage optimization according to aspects of the present invention;

FIG. 3 shows an expanded view of the system of FIG. 2 illustrating details of the webpage optimizer block;

FIG. 4 shows a conventional webpage analyzed by the invention and separated into areas for chunking;

FIG. 5 illustrates the content areas from the diagram of FIG. 4 after the chunking process;

FIG. 6 illustrates a TOC produced from the headers of the chunk pages of FIG. 5 which are in turn derived from the content of the webpage of FIG. 4;

FIG. 7 shows a flow diagram which illustrates an example navigation inference process in accordance with aspects of the present invention;

FIG. 8 shows a flow diagram which illustrates an example chunk identification process in accordance with aspects of the present invention;

FIG. 9 shows a flow diagram which illustrates an example transformation and adaptation inference process in accordance with aspects of the present invention;

FIG. 10 shows a system which illustrates various end user devices accessing webpages from a server via the internet where the webpage optimizer of FIG. 2 is contained in the end user devices;

FIG. 11 shows a system which illustrates an embodiment in which webpage optimization occurs without a request from the end user;

FIG. 12 shows a system illustrating an embodiment in which one content database is migrated to another while simultaneously performing webpage optimization;

FIG. 13 shows a diagram which illustrates embodiments using webpage optimization on search lists produced by a conventional search engine; and

FIG. 14 shows a system where aspects of the present invention are used to manage personal web content.

### DETAILED DESCRIPTION

The present invention provides significantly improved accessibility of website content on mobile and tablet devices with an emphasis on preserving the original intent of the content author/designer by inferring the characteristics of Navigability, Content Organization and chunking and then adapting the original content for multiple end user device profiles using a rule based techniques. This unique solution for adapting and repurposing the website content to display on mobile and tablet devices efficiently addresses the issues with information searching, navigation constraints of the devices, the content organization, information clutter and information overload on web pages and adapting the content to leverage device specific features by generating extensible user interface widget code.

One aspect of the present invention is drawn to “chunking” whereby the structure and content of a webpage is analyzed for clusters of certain types of content such as main navigation menus, articles or stories, structured content, advertising and branding and so on, wherein the types being inferred are from the properties of the content. The implied boundaries of the clusters are also determined to allow separation of the content into chunks. Another aspect of the present invention is drawn to a method for listing the chunks of content of an entire page in a Table of Contents (TOC) to provide a summary of content and links to the content chunks in order to improve navigation and viewing on small screens. Another aspect of the invention is drawn to adapting and tailoring website content to different types and models of mobile devices.

In addition, aspects of the present invention are adaptable to a range of uses as a commercial or a personal, third-party or user-owned service through the flexibility and portability of the invention, which allows it to reside at a third party facility, the website facility or on the mobile device itself.

Another aspect of the present invention is drawn to enhancing content database migration, whereby PC-targeted original content on one database is migrated to a second database with the webpage analysis and adaptation for mobile devices being performed simultaneously.

Another aspect of the present invention is drawn to enhancing search engines for the mobile device user by providing search results with previews and links to mobile adapted content.

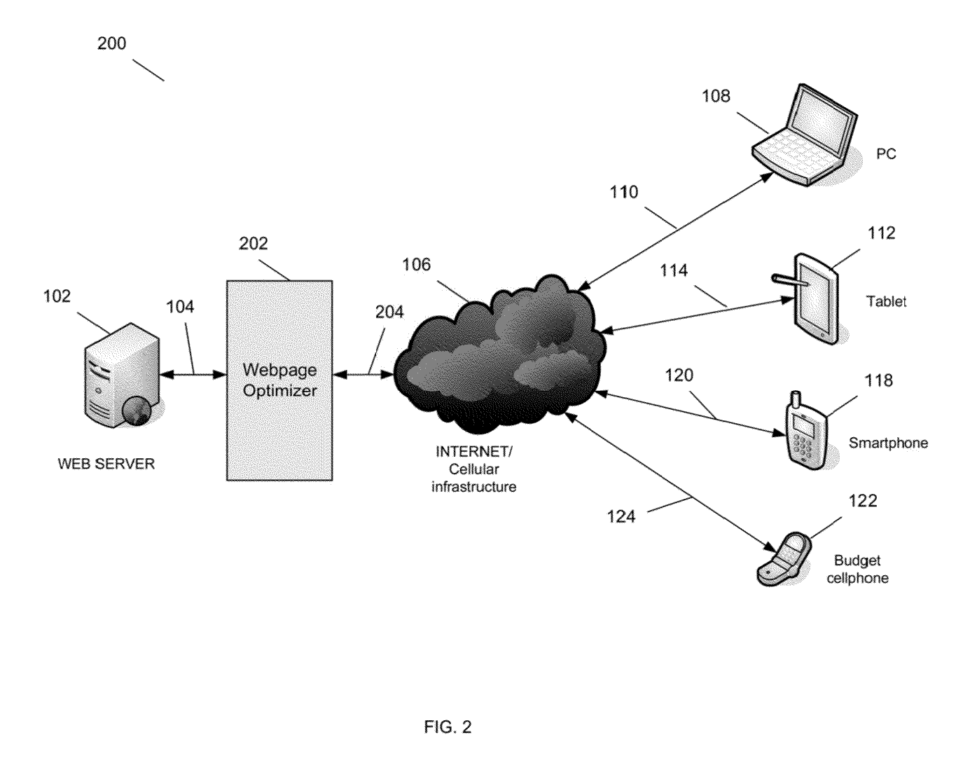

Aspects of the present invention summarized above are described in more detail with reference to the figures FIG. 2 through FIG. 10.

FIG. 2 shows system 200, which includes conventional system 100 and a webpage optimizer in according to aspects of the present invention.

As shown in the figure, system 200 includes web server 102. Personal Computer (PC) 108, tablet 112, smartphone 118 and budget cellphone 122 and a webpage optimizer 202.

In the figure, PC 108 is arranged to access original webpages from web server 102 via internet signal 110, internet/cellular infrastructure 106, an internet signal 204, webpage optimizer 202 and signal 206. Tablet 112 is arranged to access optimized webpages from webpage optimizer 202 via internet signal 114, internet/cellular infrastructure 106 and internet signal 204. Smartphone 118 is arranged to access optimized webpages from webpage optimizer 202 via internet signal 120, internet/cellular infrastructure 106 and internet signal 204. Budget cellphone 122 is arranged to access optimized webpages from webpage optimizer 202 via an internet signal 124, internet/cellular infrastructure 106 and internet signal 204. Webpage optimizer 202 is arranged to access web server 202 via signal 206.

Web server 102, PC 108, tablet 112, smartphone 118 and budget cellphone 122 provide their conventional functions as in conventional system 100. Webpage optimizer 202 creates, stores and adapts optimized webpages from original webpages fetched from web server 102, and presents such optimized webpages for use by tablet 112, smartphone 118 and budget cellphone 122.

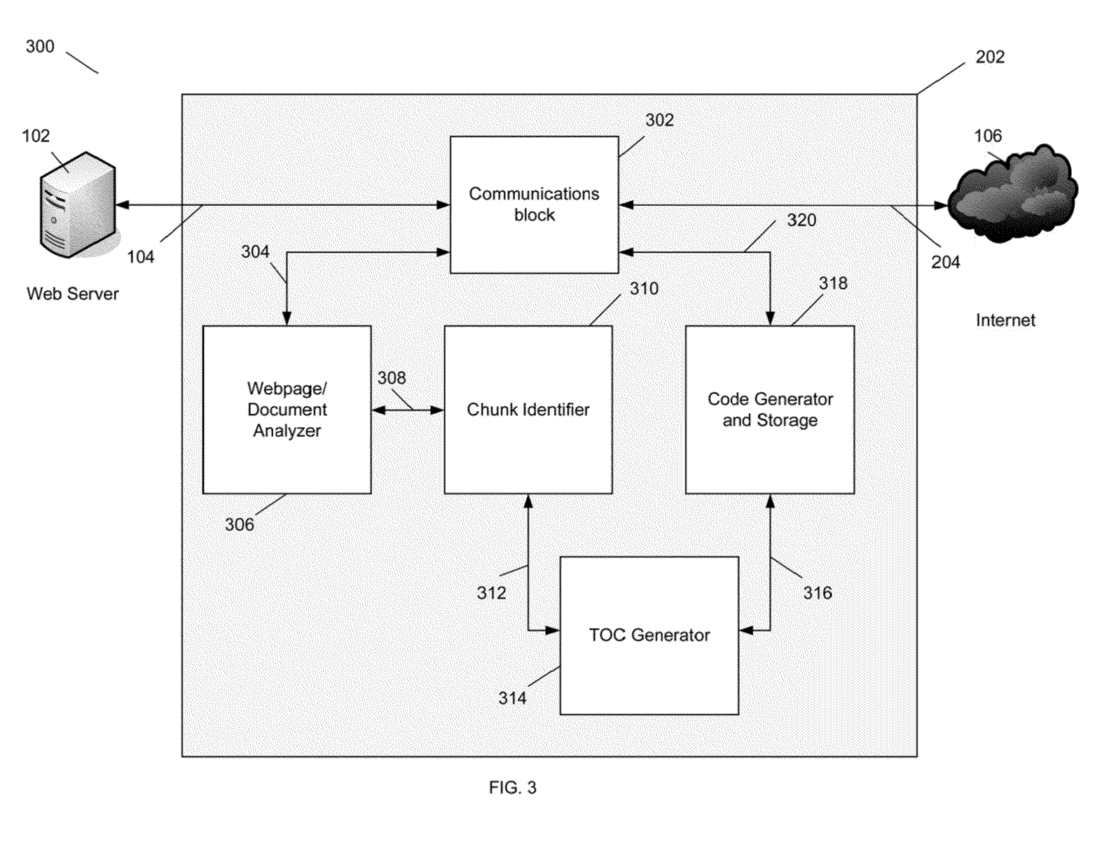

FIG. 3 shows system 300, which includes an expanded view of system 200 illustrating details of the webpage optimizer 202.

As shown in the figure system 300 includes web server 102, webpage optimizer 202 and Internet/cellular infrastructure 106. Webpage optimizer 202 includes a communication component 302, a webpage analyzing component 306, a chunk identifying component 310, a Table of Contents (TOC) generating component 314 and a code generating component 318.

Conmmunications block 302 is arranged to communicate with web server 102 via signal 104 and the Internet via internet signal 204 and internet/cellular infrastructure 106. Webpage analyzing component 306 is arranged to communicate with web server 102 via signal 304 and communications block 302. Chunk identifying component 310 is arranged to communicate with webpage analyzing component 306 via signal 308 and TOC generating component 314 via signal 312. TOC generating component 312 is arranged to communicate with code generating component 318 via signal 316. Code generating component 318 is arranged to communicate over the internet via signal 320 and communications block 302.

In this example, communication component 302, webpage analyzing component 306, chunk identifying component 310, TOC generating component 314 and code generating component 318 are distinct elements. However, in some embodiments, at least two of communication component 302, webpage analyzing component 306, chunk identifying component 310, TOC generating component 314 and code generating component 318 may be combined as a unitary device. In other embodiments, at least one of communication component 302, webpage analyzing component 306, chunk identifying component 310, TOC generating component 314 and code generating component 318 may be implemented as a computer having stored therein tangible, non-transitory, computer-readable media for carrying or having computer-executable instructions or data structures stored thereon. Such tangible, non-transitory, computer-readable media can be any available media that can be accessed by a general purpose or special purpose computer. Non-limiting examples of tangible, non-transitory, computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a tangible, non-transitory, computer-readable medium. Combinations of the above should also be included within the scope of tangible, non-transitory, computer-readable media.

Communication component 302 provides communications routes and communications control between all devices connected thereto. Webpage analyzing component 306 fetches webpages from web server 102, analyses the webpage structure and parses the content accordingly. Chunk identifying component 310 analyses the parsed content for clusters implying certain different types of material and creates blocks of information called “chunks.” TOC generating component 314 analyses the chunks and determines the chunk headers which it uses to create a TOC for portions of the original webpage. Code generating component 318 converts the TOC and the chunks linked to the TOC line items (headers) into a markup code such as XML, then transforms and stores these items, adapted to various device types as display widgets, for access by the end user.

In one embodiment, adaptation to device types can be done using individual device profiles for each existing end user device. In another embodiment, adaptation to device types can be done using a subset of device profiles and end user devices. This embodiment saves storage space. In yet another embodiment, adaptation to device types can be done using a plurality of generic device profiles which between them approximately match most device profiles. In this embodiment, devices use the generic profile with the closet match. This embodiment saves storage space and covers most devices.

The layout of a webpage to be analyzed can best be illustrated in a diagram.

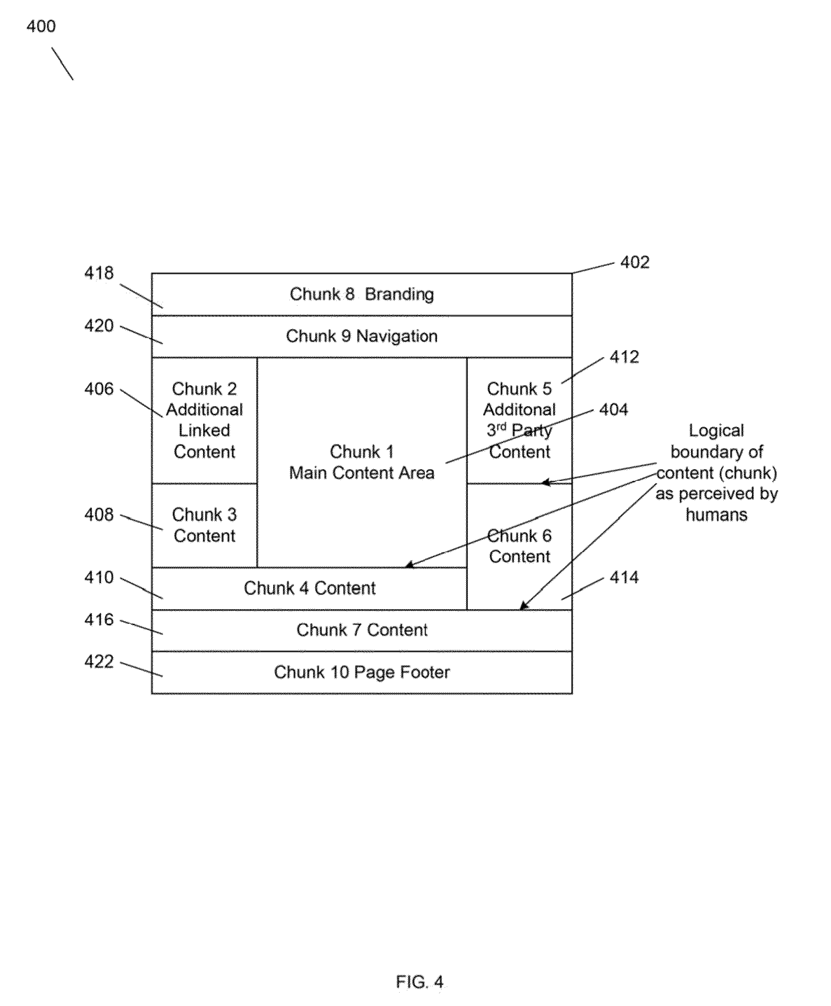

FIG. 4 shows an example diagram 400 showing a conventional webpage analyzed by the invention and separated into areas for chunking.

As shown in the figure, an example conventional webpage 402 includes a main content area 404, a linked content area 406, a content area 408, a content area 410, a 3^{rd} party content area 412, a content area 414, a content area 416, a branding area 418, a navigation area 420 and a page footer area 422.

In the figure, main content area 404, linked content area 406, content area 408, content area 410, 3^{rd} party content area 412, content area 414, content area 416, branding area 418, navigation area 420 and page footer area 422 are arranged to represent their conventional positions on a conventional webpage.

Returning to FIG. 3, chunk identifying component 310 analyses the webpage 402 by applying filters representing a set of rules, properties and property thresholds to logically determine what a human would visually perceive as visual boundaries of certain areas, each with a certain type of content, and the type of that content. Non-limiting examples of types of content include branding such as a company's logo as in branding area 418, main website navigation menu areas, with for instance internal website links to Home, About, Products, Contact, etc., as in navigation area 420, other navigation areas with links to other pages on the website as in linked content area 406, an area with a main news article or a story as in main content area 404, other articles or stories as in content areas 408, 410, 414 and 416, external links to 3^{rd} party webpages as in 3^{rd} party content area 412, and footer content such as copyrights and footer navigation items as in page footer area 422.

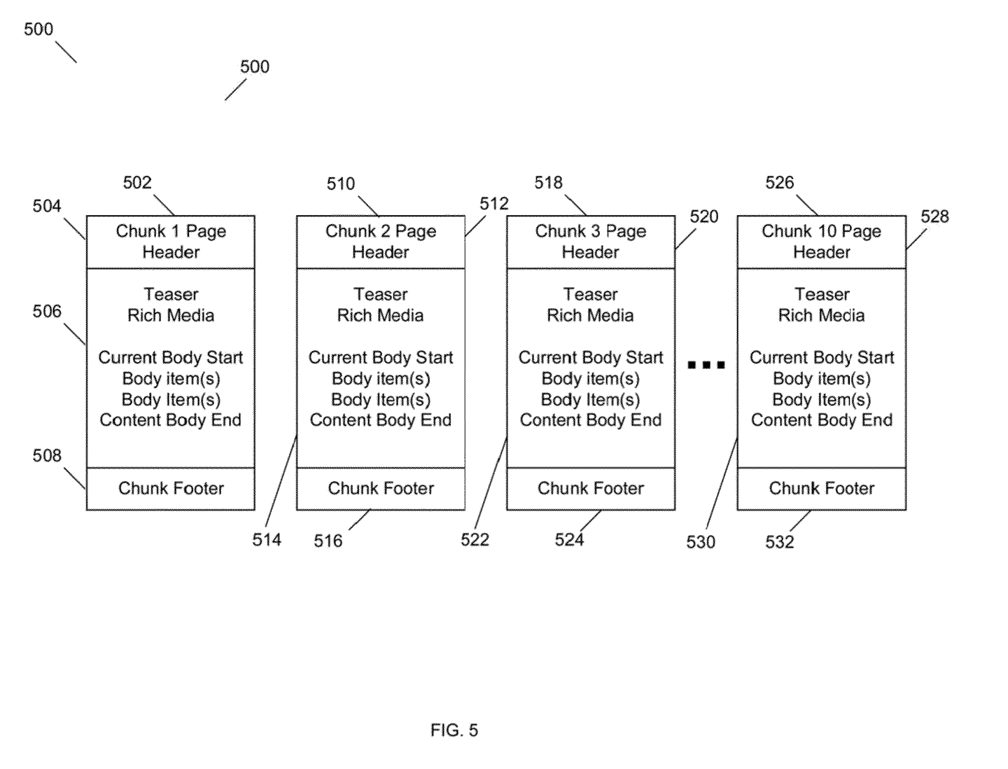

The next stage, known as “chunking,” will now be further described with reference to FIG. 5.

FIG. 5 shows diagram 500 which illustrates the content areas from diagram 400 of FIG. 4 after the chunking process.

As shown in FIG. 5, diagram 500 includes a chunk page 502, a chunk page 510, a chunk page 518 and a chunk page 526. Chunk page 502 includes a header 504, a body 506 and a footer 508. Similarly, chunk page 510 includes a header 512, a body 514 and a footer 516. Chunk page 518 includes a header 520, a body 522 and a footer 524. Chunk page 526 includes a header 528, a body 530 and a footer 532.

In the figure, chunk page 502, chunk page 510, chunk page 518 and chunk page 526 correspond to content area 404, content area 406, content area 408 . . . , and content area 416 of diagram 400 of FIG. 4.

Once the boundaries of a chunk have been identified, the header text and the footer area can be located. For example, header 504 of chunk page 502 is the first area of text within the content area 404. If content area 404 is, for instance, a newspaper article, header 504 would capture the headline or title of the story. Body 506 of chunk page 502 includes content within content area 404 of FIG. 4. Chunk footer 508 of chunk page 502 includes the area of text after the body 506 and would capture, for instance, any conclusion, summary, call to action link or author information for the article.

Diagram 500 of the figure illustrates the series of ten chunk pages that are created from the analysis of the original webpage 402 from FIG. 4 and the separation and grouping of content performed by the chunking process. As described above, each chunk page comprises a header, a footer, and a body which contains the main text, rich media such as a photographs or a video window and any other items within the content area.

For each chunk, the chunk header text is used to create the entry in a Table of Contents (TOC). The TOC and its entries allow the end user to reference the chunks. This is analogous to the list of chapters in the Contents section at the front of a book.

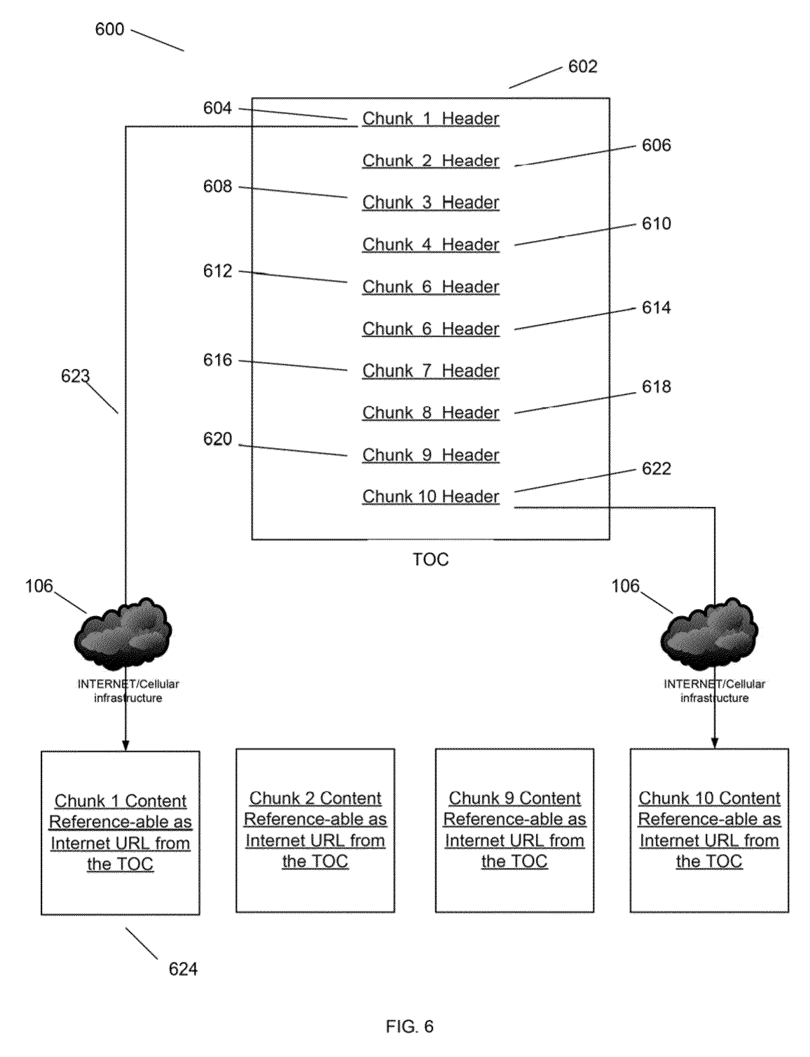

FIG. 6 shows a TOC 602 produced from the headers of the chunk pages of diagram 500.

As shown in FIG. 6, TOC 602 includes a line item 604, a line item 606, a line item 608, a line item 610, a line item 612, a line item 614, a line item 616, a line item 618, a line item 620 and a line item 622.

Line items 604, 606, 608, 610, 612, 614, 616, 618, 620 and 622 correspond to the headers from the chunk pages 1 through 10, respectively, a sample of which are shown in diagram 500. In this example embodiment, the line items of TOC 602 are shown as hyperlinks.

Thus, TOC 602 provides information to the end user of the existence of webpage sections, i.e. the chunks, which might otherwise be missed on mobile and tablet devices accessing the original webpage due to the curtailed viewing area of the device. The hyperlinks within TOC 602 enable the user to navigate to the other website sections.

For purposes of explanation, consider the situation where a user of smartphone 118, of FIG. 2, wants to view the webpage of web server 102. In this situation, let the webpage of web server 102 be constructed so as to be entirely viewed by PC 108, as shown in FIG. 4. Further, for purposes of this discussion, presume that smartphone 118 is unable to view the entire webpage 402 in its screen.

In accordance with aspects of the present invention, webpage optimizer 202 is able to reorganize the content of webpage 402 into chunks, wherein each chunk may be entirely viewed in the screen of smartphone 118. Examples of such chunks are shown in FIG. 5.

In accordance with aspects of the present invention, webpage optimizer 202 is additionally able to generate a TOC such that the user of smartphone 118 can easily navigate about the many chunks created by webpage optimizer 202. An example of a TOC is shown in FIG. 6.

Therefore, instead of viewing a portion of webpage 402, the user of smartphone 118 will easily see an entire TOC associated with webpage 402. Upon selection of one of the items in the entirely viewed TOC, the user of smartphone 118 will additionally be above to view an entire distinct portion of webpage 402.

In some embodiments, webpage optimizer 202 performs webpage optimization dynamically, whereas in other embodiments, webpage optimizer 202 performs webpage optimization statically.

In the dynamic sense, webpage optimizer 202 may perform webpage optimization when needed. For example, as discussed above, in the situation where smartphone 118 is attempting to view webpage 402, webpage optimizer 202 may perform webpage optimization at that time. In these cases, webpage optimizer 202 would be pulling content from web server 102.

In the static sense, webpage optimizer 202 may perform webpage optimization as instructed by a server. For example, in a situation where web server 102 wants to create alternative forms of an original webpage in order to support many types of end user devices, webpage optimizer 202 may perform webpage optimization at that time. In these cases, web server 102 would be pushing content to webpage optimizer 202.

The processes described at a higher level in FIGS. 2-6 above are explained in more detail in the following figures. The structure analysis and identification of the main navigation menu of a website is performed in a navigation inference process performed by webpage analyzing component 306 of FIG. 3. In an example embodiment, various logical chunks of a webpage (as perceived by humans) along with boundaries of the chunks and the header, footer and body items are identified in a chunk identification process performed by chunk identifying component 308 and the creation of a TOC of chunk entries by TOC generating component 314; the code generation and adaptation to specific user device types is performed by a transformation and device adaptation process performed by code generator and storage component 318.

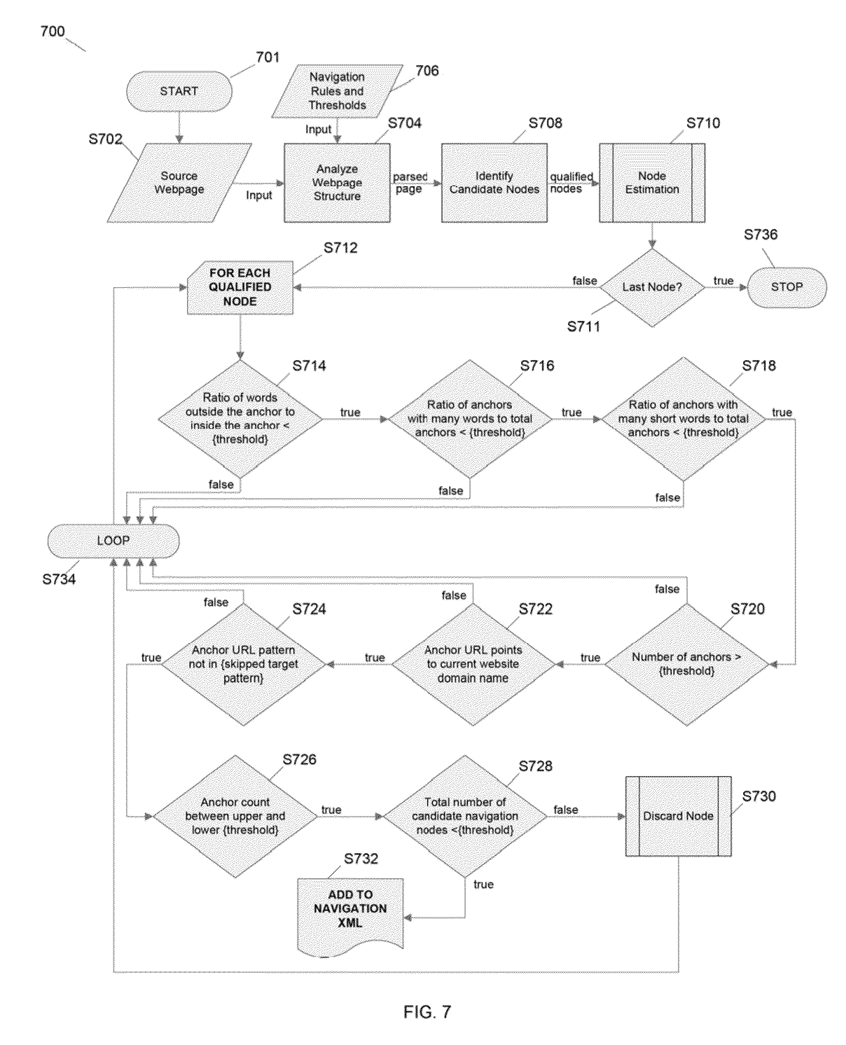

FIG. 7 illustrates an example navigation inference process 700 performed by webpage analyzing component 308 of FIG. 3, in accordance with aspects of the present invention.

Process 700 starts (S701) and a webpage is fetched from the source (S702) for analysis. For example, referring to FIG. 3, webpage analyzing component 306 fetches a webpage's HTML code from web server 102 via communications component 302 for analysis of its structure and syntax.

Returning to FIG. 7 while applying various navigation rules and thresholds (S706) the webpage HTML is analyzed for its structure and syntax (S704) to produce a parsed page. Non-limiting examples of navigation inference rules and thresholds applied in the description above include: number of pages to process threshold, number of parallel page crawling threads, minimum standalone coverage for navigation qualification threshold, minimum cluster coverage for navigation qualification threshold, minimum threshold for merging by similarity of targets, minimum threshold for merging by inclusion of targets, minimum merging by inclusion ratio of targets threshold, maximum navigation nodes per page, minimum target count and maximum target count.

The parsed page is then tested to identify nodes which are candidates as navigation (menu) nodes (S708). A node is a portion of page html tree that is a potential candidate to become a chunk.

For example, the fetched webpage's structure is analyzed by webpage analyzing component 306 of FIG. 3, which uses crawling threads to scan and index the HTML code. Then the parsed structure is passed to chunk identifying component 310 which identifies the candidates by looking for certain navigation properties, for example clusters of hyperlinks, and by applying the navigation inference rules and thresholds.

Returning to FIG. 7, the nodes are then estimated (S710). This estimation process consumes the remaining portion of process 700 (S712-S736).

It is first determine whether the current node being analyzed is the last node (S711). If the current node being analyzed is the last node (true at S711), then process 700 stops (S736). For example, qualified nodes are counted by chunk identifying component 310 which allows further processing to occur on each qualified node until the last node is reached, at which point process 700 stops (S736).

If the current node being analyzed is not the last node (false at S711) then a recurring process is performed for each qualified node starts (S712). This recurring process consumes the remaining portion of process 700 (S714-S736).

For each qualified node, it is determined whether the ratio of the number words outside the anchor to the number of words inside the anchor is less than a predetermined threshold T₁ (S714). An anchor is a section of text, which forms a weblink (URL). For example, webpage analyzing component 306 may use the ratio threshold T₁ to determine if the links are appearing contiguously in a node and likely to be menu URLs, or if they are scattered across text and paragraphs and so may be content related and not necessarily a menus URL. An example range of values for T₁ is 0.25 to 0.5.

In the event that the ratio of the number words outside the anchor to the number of words inside the anchor is greater than or equal to predetermined threshold T₁ (false at S714), the process continues (S734) wherein the current node is discarded and the recurring process starts again (S712) for the next qualified node. In this situation, the current node is determined not likely to be a navigational menu node, so it may be ignored for purposes of process 700.

In the event that the ratio of the number words outside the anchor to the number of words inside the anchor is less than predetermined threshold T₁ (true at S714), this suggests contiguous links. Accordingly, there is an increased likelihood that the current node is a menu. The current node may then be further scrutinized, wherein is determined whether the ratio of anchors with many words to total anchors is less than a predetermined threshold T₂ (S716). For example, webpage analyzing component 306 may analyze the node with respect to its wordiness. An example range of values for T₂ is 0.25 to 0.9.

In the event that the ratio of anchors with many words to total anchors is greater than or equal to predetermined threshold T₂ (false at S716), the process continues (S734) wherein the current node is discarded and the recurring process starts again (S712) for the next qualified node. In this situation, since the wordiness of the node is high, the current node is determined unlikely to be a navigational menu node, so it may be ignored for purposes of process 700.

In the event that the ratio of anchors with many words to total anchors is less than predetermined threshold T₂ (true at S716), this suggests that the wordiness of the node is low. Accordingly, there is an increased likelihood that the current node is a navigational menu node. The current node may then be further scrutinized, wherein it is determined whether the ratio of anchors with many short words to total anchors is less than a predetermined threshold T₃ (S718). For example, webpage analyzing component 306 may analyze the node to eliminate strings of short words which are not menu items such as search result page numbers (e.g. 1, 2, 3, 4 . . . ) or dated archives (e.g. 2001, 2002, 2010 . . . ). An example range of values for T₃ is 0.2 to 0.5.

In the event that the ratio of anchors with many short words to total anchors is greater than or equal to predetermined threshold T₃ (false at S718), this suggests that there are a lot of short worded links likely to be dated archives for example and so the process continues (S734) wherein the current node is discarded and the recurring process starts again (S712) for the next qualified node. In this situation, the current node is determined not to be a navigational menu node, so it may be ignored for purposes of process 700.

In the event that the ratio of anchors with many short words to total anchors is less than predetermined threshold T₃ (true at S718), this suggests that there are not a lot of short worded links. Accordingly, there is an increased likelihood that the current node is a navigational menu node. The current node may then be further scrutinized, wherein it is determined whether the number of anchors is more than a predetermined threshold T₄ (S720). For example, webpage analyzing component 306 may analyze the node to determine if it has a co-located plurality of links. In a non-limiting example embodiment, the minimum value of T₄ is 2.

In the event that the number of anchors is less than or equal to predetermined threshold T₄ (false at S720), this suggests that this is not a cluster of links and the process continues (S734) wherein the current node is discarded and the recurring process starts again (S712) for the next qualified node. In this situation, the current node is determined not to be a navigational menu node, so it may be ignored for purposes of process 700.

In the event that the number of anchors is greater than predetermined threshold T₄ (false at S720), this suggests that this is a cluster of links. Accordingly, there is an increased likelihood that the current node is a navigational menu node. The current node may then be further scrutinized, wherein it is determined whether the anchor URL points to the current website domain name (S722). For example, analyzing component 306 may analyze the node to determine if the anchor URL is an internal link or an external link.

In the event that the anchor URL does not point to the current website domain name (false at S722), this determines that this is an external link not related to a navigational menu of internal links and the process continues (S734) wherein the current node is discarded and the recurring process starts again (S712) for the next qualified node. In this situation, the current node is determined not to be a navigation node, so it may be ignored for purposes of process 700.

In the event that the anchor URL points to the current website domain name (true at S722), this suggests that the link is internal. Accordingly, there is an increased likelihood that the current node is a navigational menu node. The current node may then be further scrutinized, wherein it is determined whether the anchor URL pattern is not in (S724). URL pattern not in means the URL is a not a match for allowed URL patterns. For example, analyzing component 306 may analyze the node for URL pattern in order to eliminate javascript/images/pdf links.

In the event that the anchor URL pattern is not in (true at S724), the process continues (S734) wherein the current node is discarded and the recurring process starts again (S712) for the next qualified node. In this situation, the current node is determined to be a Javascript/images/pdf link, so it may be ignored for purposes of process 700.

In the event that the anchor URL pattern is in (false at S724), this suggests that the current node is not determined to be a Javascript/images/pdf link. Accordingly, the current node may then be further scrutinized, wherein it is determined whether the anchor count is between the upper and lower thresholds, T₅ and T₆ respectively (S726). For example, analyzing component 306 may analyze the node to determine if the node has so few or so many links that the links are unlikely to be menu links. In a non-limiting example embodiment, T₅=2 and T₆=200.

In the event that the anchor count is not between T₅ and T₆ (false at S726), the process continues (S734) wherein the current node is discarded and the recurring process starts again (S712) for the next qualified node. In this situation, the current node is determined not to be a navigation node, so it may be ignored for purposes of process 700.

In the event that the anchor count is between T₅ and T₆ (true at S726), this suggests that the node has a reasonable number of links. Accordingly, there is an increased likelihood that the current node is a navigational menu node. The current node may then be further scrutinized, wherein it is determined whether the total number of candidate navigation nodes is less than a predetermined threshold T₇ (S728). For example, analyzing component 306 may determine if there are so many total menu nodes that the page is more likely to be an index webpage, for instance, rather than contain a navigational menu node. In a non-limiting example embodiment, T₇ is 50.

In the event the total number of candidate navigation nodes is greater than or equal to predetermined threshold T₇ (false at S728), the process continues (S730) wherein the current node is discarded and the recurring process starts again (S712) for the next qualified node. In this situation, the current node is determined not to be a menu navigation node, so it may be ignored for purposes of process 700.

In the event the total number of candidate navigation nodes is less than predetermined threshold T₇ (true at S728), this suggests that this is not an index webpage. Accordingly, the current node is considered a navigational node and is added to a navigation XML file (S732).

In an example embodiment, chunk identifying component 310 of FIG. 3 performs all the tests of the recurring series of tests described above on all the qualified candidate navigation nodes. It rejects and discards those which do not pass any one of the tests and it adds those that pass all the tests to the navigation XML file i.e. they are convened to a markup language such as XML and stored for chunk identification process to process individual webpages as identified in navigation xml.

At this point, the website has been analyzed for navigation nodes and stored as navigation xml. The individual pages are then subjected to the chunk identification process. In an example embodiment, the chunk identification process produces the chunks and is performed by chunk identifying component 310 of FIG. 3.

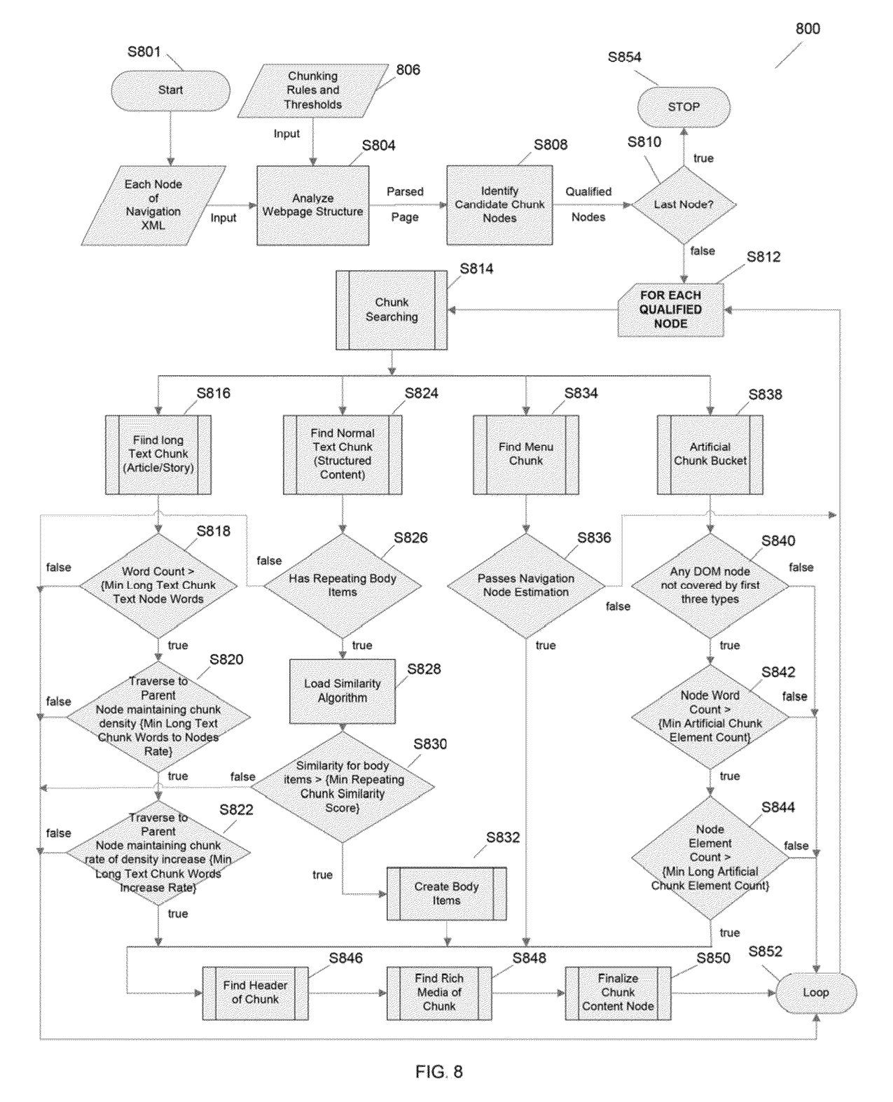

FIG. 8 illustrates an example chunk identification process 800 in accordance with aspects of the present invention. All functions of process 900 are performed by chunk identifier component 310 of FIG. 3.

Process 800 starts (S801) and a webpage is fetched from the source (S802) for analysis. For example, referring to FIG. 3, chunk identifying component 310 which has already stored the navigation XML of the website, fetches the individual webpage code for analysis of its structure and syntax.

Returning to FIG. 8, while applying a plurality of navigation rules and thresholds 806 the webpage is parsed and Document Object Model (DOM XML) is constructed for further analysis of the page structure and syntax (S804).

Non-limiting examples of inference rules and thresholds 806 include: max references in a chunk, max words per item in structurally repeating chunks, min article type chunk size, min article type chunk density, min article type chunk rate of density increase, min structurally repeating body item similarity score, min artificial chunk size, min artificial chunk density. Wherein, it is capable of identifying chunk types, non-limiting examples of which include navigation menus, articles, structurally repeating content and similar pattern of chunks.

The parsed page is then tested to identify nodes which are candidates as chunks (S808). For example, the fetched webpage's structure may be analyzed by chunk identifying component 310 of FIG. 3, which may use crawling threads to scan and index the DOM XML code. Then the parsed structure is passed within chunk identifying component 310, which then identifies chunk candidates by looking for various properties.

Returning to FIG. 8, it is first determine whether the current node being analyzed is the last node (S810). If the current node being analyzed is the last node (true at S810), then process 800 stops (S854). For example, qualified nodes are counted by chunk identifying component 310, which allows further processing to occur on each qualified node until the last node is reached, at which point process 800 stops (S854).

If the current node being analyzed is not the last node (false at S810), then the current node (S812) is subjected to a series of tests (S814).

Firstly, long text chunks are tested (S816), which includes three determinations (S818-S822). Non-limiting examples of long text chunks include stories, news articles and chunks thereof.

For each qualified node, it is determined whether the word count is greater than a predetermined threshold T₈ corresponding to a minimum long text chunk text node words (S818). For example, chunk identifying component 310 analyzes the node to determine if the chunk type is an article based on the number of long text chunk node words. In a non-limiting example embodiment, the value for T₈ is 100 words.

In the event that the word count is less than or equal to threshold T₈ (false at S818), this suggests that the node is too short to be an article or story chunk and no further determination of this node as a long text chunk is done.

In the event that the word count is greater than threshold T₈ (true at S818), this suggests that the node is likely a long article or story chunk. The current node may then be further scrutinized, wherein it is determined whether it can traverse to the parent node while maintaining a predetermined ratio T₉ corresponding to a minimum long text chunk words to nodes ratio (chunk density) (S820). For example, chunk identifying component 310 traverses the DOM XML and as it does so it may encounter other internal tags of a webpage code that represent other elements other than text words. The relative rate at which the word density increases should be greater than the rate at which the other tag densities increase. In a non-limiting example embodiment, the range for the value of T₉ is 3 to 10.

In the event that it cannot traverse to the parent node while maintaining the minimum long text chunk words to nodes ratio (chunk density) (false at S820), then process 800 loops (S852), wherein then next qualified node is analyzed (S812).

In the event that it traverses to the parent node while maintaining the minimum long text chunk words to nodes ratio (chunk density) (true at S820), this suggests that there is an increased likelihood that the current node is an article.

The current node may then be further scrutinized, wherein it is determined whether it can traverse to the parent node while maintaining a predetermined threshold T₁₀ corresponding to a minimum long text chunk words increase rate (chunk rate of density increase) (S822). For example, chunk identifying component 310 analyzes the node using threshold T₁₀ for chunk rate of density increase to determine if the long article is entirely contained within the chunk. In a non-limiting example embodiment, the range of values for T₁₀ is 1.5 to 3.0.

In the event that it cannot traverse to the parent node while maintaining the minimum long text chunk words increase rate (chunk rate of density increase) (false at S822). This suggests that the node is not an article and no further determination of this node as a long text chunk is performed. Determination of other chunk types, however continues.

In the event that it traverses to the parent node while maintaining the minimum long text chunk words increase rate (chunk rate of density density) (true at S822), this suggests that the chunk is a long text chunk. At this point, the header of the chunk is determined (S846). This will be described in greater detail later.

At this point process 800 then determines whether the current node is for normal text chunks (structured content) (S824). Non-limiting examples of normal text chunks include structural content with a repeating pattern of content; results from a database; a table with rows and columns (e.g. Excel spreadsheet).

For each qualified node, it is then determined whether the current node has repeating body items (S828). For example, identifying component 310 analyzes the node to find structural content with a repeating pattern of content.

If the current node does not have repeating body items (false at S826), this suggests that the chunk is not a normal text chunk and no further determination of this node as a normal text chunk is done. Determination of other chunk types, however continues.

If the current node has repeating body items (true at S826), this suggests that the current node is structured content with a repeating pattern of content. The current node may then be further scrutinized, wherein it is determined whether the similarity for body items score is greater than the minimum repeating similarity score T₁₁ (S830). For example, chunk identifying component 310 analyzes the repeating pattern within the structured content to determine the similarity between multiple occurrences. In a non-limiting example embodiment, the range for the value of T₁₁ is 0.5 to 0.68.

If the similarity for body items score is less than or equal to the minimum repeating similarity score T₁₁ (false at S830), this suggests that the chunk is not a normal text chunk and no further determination of this node as a normal text chunk is performed. Determination of other chunk types continues.

If the similarity for body items score is greater than the minimum repeating similarity score (true at S830), then the chunk is a normal text chunk. At this point, process the body items are created (S832). For normal text chunks (structured content) the body is expected to be broken into body items where, like records of a database table, each body item represents a row of structured data.

At this point, the header of the chunk is determined (S846). This will be described in greater detail later.

At this point, process 800 then determines whether the current node is a navigation chunk (S824), which corresponds to process 700 discussed above with reference to FIG. 7. The determination is summarized in the figure as a determination of navigation node estimation (S836). If it is determined that the current node is not a navigation node (false at S836), then no further determination of this node as a normal text chunk is performed. Determination of the other chunk types, if any remain, continues. Alternatively, if it is determined that the current node is a navigation node (true at S836), then the header of the chunk is determined (S846). This will be described in greater detail later.

For each qualified node it is then determined whether the current node belongs in the artificial chunk bucket (S838).

First, is determined whether the node has not already been deemed by the previous tests to be one of the other three types of chunk, that is, a long text chunk, a normal text chunk or a menu-like chunk (S840). If it has been so deemed (false at S840), then the current node has already been successfully profiled as a specific type of chunk and no further processing for the artificial chunk bucket is done.

If it is determined that the node has not already been deemed by the previous tests to be one of the other three types of chunk, that is, a long text chunk, a normal text chunk or a menu-like chunk (true at S840), then it is determined whether the node word count is greater than a predetermined threshold T₁₂ corresponding to a minimum artificial chunk element count (S842). For example, chunk identifying component 310 determines if there are enough tags to consider the node as an artificial chunk. In a non-limiting example embodiment, a value range for T₁₂ is 1 to 5. If this condition is true, the process continues (S844).

In the event that the node word count is less than or equal to the minimum artificial chunk element count T₁₂ (false at S842), the node is not considered an artificial chunk, is not put in the artificial chunk bucket and the process continues with profiling other nodes.

In the event that the node word count is greater than a predetermined threshold T₁₂ (true at S842), it is then determined whether the node element count is greater than a predetermined threshold T₁₃ corresponding to a minimum long artificial chunk element count (S844). In a non-limiting example embodiment, a value range for T₁₃ is 1 to 5. If it is determined that the node element count is less than or equal to the predetermined threshold T₁₃ (false at S844), then the node is too small to be considered an artificial chunk (it may be an internal HTML markup). It is not put in the artificial chunk bucket and the process continues with profiling other nodes.

If it is determined that the node element count is greater than the predetermined threshold T₁₃ (true at S844), the header for the chunk is determined (S846).

For all these four types the process continues with finding the header for the chunk (S846). For example, chunk identifying component 310 may look at the initial set of tags in the chunk boundary and will identify the header text by using visual clues such as H1-H6 tags, font size, bold type, CSS properties and header-like CSS classes.

Then, any rich media is found (S848). For example, chunk identifying component 310 may identify rich media by looking for tags such as img, object, activex and video tags.

Finally, the chunk content has been finalized (S850). For example, chunk identifying component 310 may employ non-limiting aggregation techniques such as “what-if” analysis as well as merging of contiguous chunks that follow a certain common coordinate location in the DOM XML tree structure.

The process then continues for the next qualified node (S814) until the last node has been processed.

At this point chunks have been identified along with their boundaries (header, footer) and body items, examples of which are shown in FIG. 5. As discussed earlier for FIG. 6, the headers of the chunks are used by TOC generator 314 of FIG. 3 as line items in a TOC as a summary of the chunked webpage content and for navigation to that content for the mobile user.

In the non-limiting example embodiment discussed above with reference to FIG. 8, chunks are profiled to be identified as one of four types of chunks based on a predetermined set of rules. This non-limiting example is provided for purposes of discussion. In other embodiments, other types of chunks may be identified based on additional or different rules.

In a further embodiment, the chunks can be adapted to the type of mobile device. This is performed by a transformation and adaptation process.

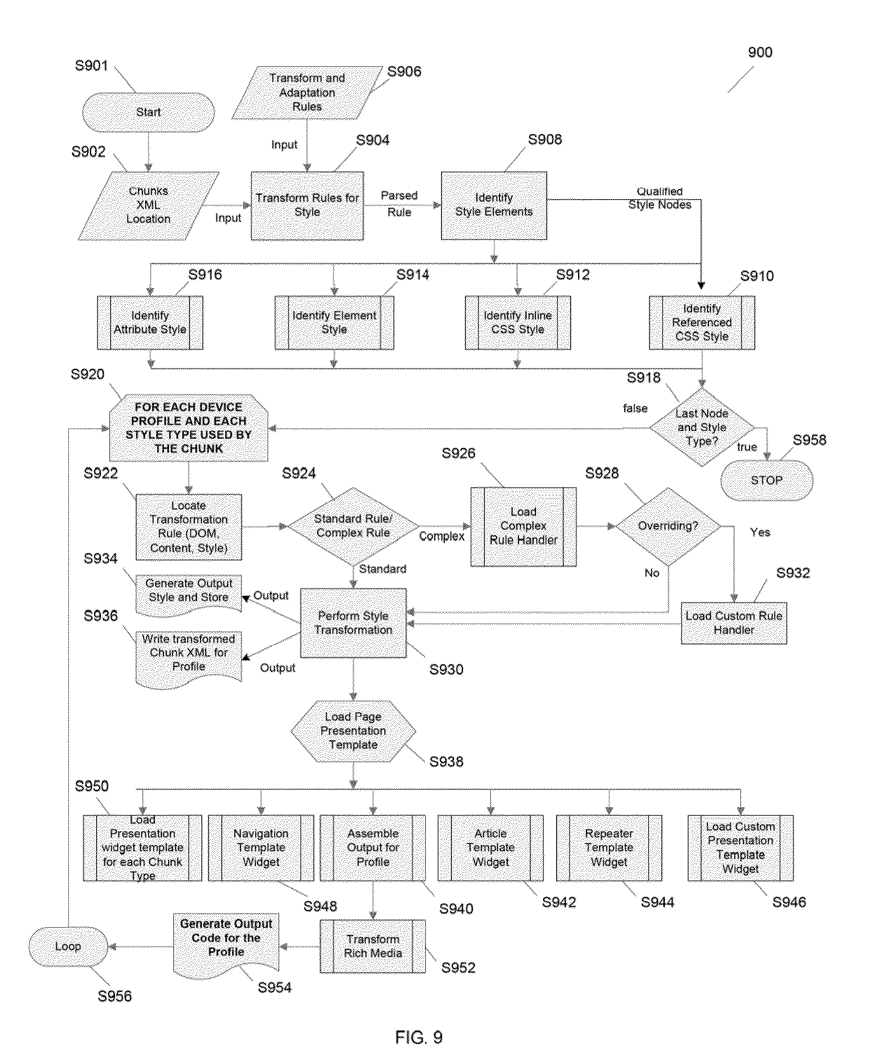

FIG. 9 shows an example transformation and adaptation process 900 in accordance with aspects of the present invention.

All functions of process 900 are performed by code generator and storage component 318 of FIG. 3.

As shown in FIG. 9, process 900 starts (S901) with chunks being stored as XML after chunking (S902). For example, chunks produced by chunking process 800 described above with reference to FIG. 8 may be stored in chunk identifier 310.

Transform and adaptation rules are then implemented (S906). Non-limiting examples of transform and adaptation rules include a set of transform rules, a list of inline styles, a list of inclusions, a Document Object Model (DOM) rule, content rule, rich media (images, video) rule, presentation template widgets (for page chunk type).

The nodes are analyzed for transform rules for style and parsed by rule (S904). The purpose of the rule is to adapt presentation properties of content to optimally view the content on a particular set of devices profiles. Non-limiting examples of such rules include: transformation rules—to adapt the manner in which a specific content element is to be presented; style rules—to adapt the style; inclusion rules—to adapt the referenced style; DOM rules—to adapt the HTML mark-up; content rules—to adapt the content: rich media rules—adapt the rich media resolution and size, and presentation template widgets, which act as a container to display specific types of chunks to simplify viewing and interaction. The rules may be defined in XML and may be applied on each webpage and chunk. Rules may also be hand coded transformation logic module that could be loaded at run time based on a predetermined rule condition.

Types of types of style elements are then identified (S908). In an example embodiment, four types of style elements are identified, which include referenced Cascading Style Sheets (CSS) style, inline CSS style, element style and attribute style. Cascading Style Sheets (CSS) is the style sheet language used for describing the presentation semantics of a document written in a markup language. Inline CSS style is the style definition inside a webpage. Element style is the style definition to be applied to a specific element or a specific type of HTML object. Attribute style is granular information about a specific aspect of a style.

Referenced CSS style is identified (S910). In an example embodiment, the referenced CCS style is identified by searching and locating link mark-ups in the webpage, from which the chunks were identified, that provide a link to a CSS file to be included in the page while presenting it.

Inline CSS style is identified (S912). In an example embodiment, the inline CCS style is identified by searching and locating global style definitions embedded inside the webpage, from which the chunks were identified.

Element style is identified (S914). In an example embodiment, the element style is identified by searching and locating style definitions attached to a specific HTML object in the chunks.

Attribute style is identified (S916). In an example embodiment, the attribute style is identified by searching and locating specific sub-elements of style definition in the chunks.

Qualified style nodes of all four types are output after style identification and the process is continued with a test for the last node and style (S918).

On the last node and style type (true at S918), the entire process is stopped (S958).

In the event that the node and style being processed is not the last node and style (false at S918), process 900 continues (S920).

For each qualified style node and for each supported device profile the applicable transformation rules are determined (S922). In an example embodiment, the applicable transformation rules are determined by matching rule definition with style definition.

It is determined if the transformation rule is a standard transform rule or a complex rule (S924). In an example embodiment, standard transformation rules are declarative in nature and do not need specific code. More complex rules may be implemented using custom code logic.

If a complex rule is determined (complex at S924) a complex rule handler is loaded (S926). In an example embodiment, a rule handler includes a specific hand-coded transformation logic module that is operable to transform a chunk from an original format to a new format that may be utilized in a specific device or device profile (category) context.

For a complex rule, it is then determined if overriding is required (S928). In an example embodiment, overriding may be required if hand-coded transformation logic can be exposed to a third party, such that the third party may change the format for their specific needs.

If overriding is required (yes at S928), a custom rule handler is loaded (S932).

In the event a standard rule is determined (standard at S924), the process continues (S930).

In the event a complex rule is determined (complex at S924) and overriding is not required (no at S928), the process continues (S930).

In the event a complex rule is determined (complex at S924) and overriding is required (no at S928) and a custom rule handler has been loaded (S932), the process continues (S930).

The style is then transformed (S930). In an example embodiment, two outputs are generated.

An output style is generated and stored (S934) from the first output.

A transformed chunk XML is written (S936) from the second output.

The process then continues with the several templates being loaded. The page presentation template is loaded (S938).

The article presentation template is loaded (S942). An article template can be designed to have higher priority of focus when presented with other types of templates. These decisions can be made based on the target device profile in advance or at run-time. Moreover, very large articles could be limited to a screen size with ability to see limited or all content.

The repeater template is loaded (S944). In an example embodiment the repeating body may be made available as a slide show.

The navigation template is loaded (S948). Excessive occurrence of navigation chunk or redundant chunks can be minimized by default to optimally use the space on constraints devices. Navigation can also be encapsulated in a toolbar to availability across the entire site.

The presentation template widget is loaded for each chunk type (S950). A presentation widget is able to reformat an original chunk to a reformatted chunk that is optimized for viewing on a predetermined device.

Then for the current profile and style the output is assembled (S940).

Any rich media are transformed in terms of their resolution and size to suit the device or device profile (category) (S952).

The output code for the processed node and profile is then generated (S954).

The process is repeated for other device profiles and nodes (S956 and S920), until the process is stopped at the last node and profile.

Returning to FIG. 3, code generator and storage component 318, after applying the transformation and adaptation process described above for each device profile supported, has generated and stored all the code necessary for supported devices to access device-optimized content for an original webpage fetched from web server 102. In this manner, many profiles may be created. For example, returning to FIG. 2, a first profile may be created for cellphone 122, a second profile may be created for smartphone 118 and a third profile may be created for tablet 112. In this example, the first profile for cellphone 122 may have a smaller size and less resolution than the second profile for smartphone 118. Similarly, the second profile for smartphone 118 may have a different size and different resolution than the third profile for tablet 112. Clearly, any number of profiles may be created to support many different user devices in accordance with aspects of the present invention.

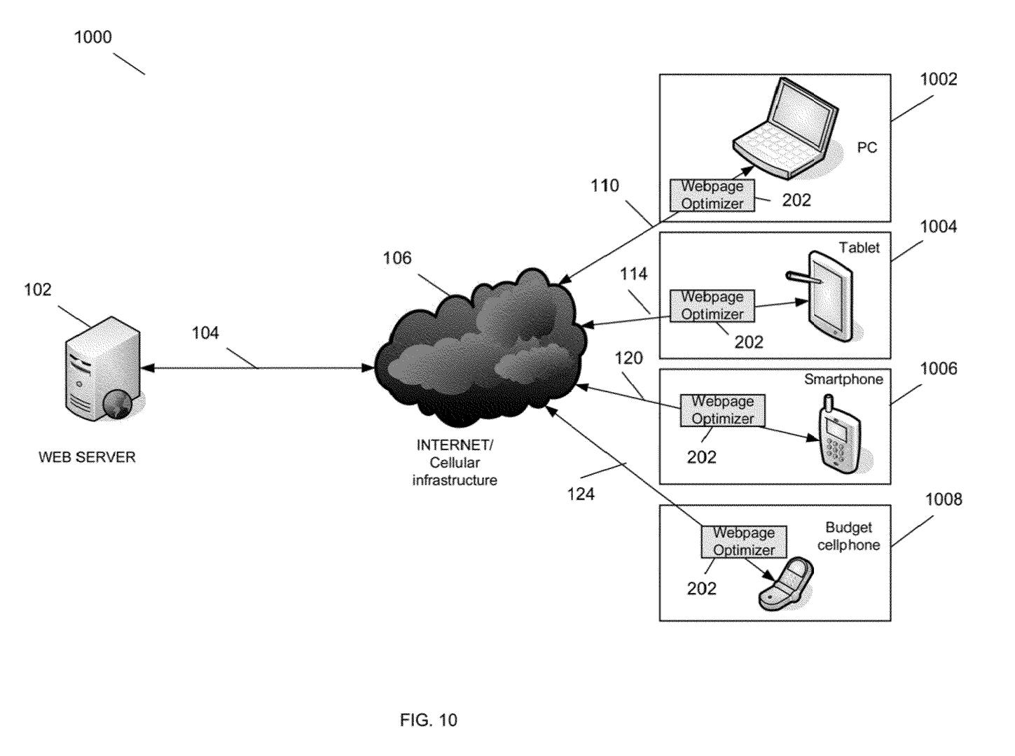

The embodiments discussed above with reference to FIG. 2 through FIG. 9 illustrate some aspects of the present invention. Other aspects will now be described with reference to FIG. 10 through FIG. 13.

In system 200 discussed above with reference to FIG. 2, webpage optimizer 202 is associated with web server 102. However, other embodiments, a webpage optimizer may be associated with an end user device. In particular, in another aspect, webpages are transformed at the user device. This will now be explained with reference to FIG. 10.

FIG. 10 illustrates a system 1000 including various end user devices accessing webpages from a server via the internet.

As shown in the figure, system 1000 includes web server 102, a Personal Computer (PC) 1002, a tablet 1004, a smartphone 1006 and a budget cellphone 1008.

In the figure, PC 1002 is arranged to access webpages on web server 102 via an internet signal 110, an internet/cellular infrastructure 106 and an internet signal 104. Tablet 1004 is arranged to access webpages on web server 102 via an internet signal 114, internet/cellular infrastructure 106 and internet signal 104. Smartphone 1006 is arranged to access webpages on web server 102 via cellular internet signal 120, internet/cellular infrastructure 106 and internet signal 104. Budget cellphone 1008 is arranged to access webpages on web server 102 via a cellular signal 124, internet/cellular infrastructure 106 and internet signal 104.

In this embodiment, a webpage optimizer similar to webpage optimizer 202 of FIG. 2 exists on tablet 1004, on smartphone 1006 and on budget cellphone 1008. Un-optimized pages are fetched over the internet from web server 102 conventionally and are loaded in the end user devices. The fetched webpages are optimized using webpage optimizer 202 and displayed on the screen of the device. An advantage of this embodiment is that any particular webpage optimizer need only to optimize and adapt webpages for its respective device.

For example, for the case where webpage optimizer 202 is residing on smartphone 1006, webpage optimizer 202 will make a request for a webpage from web server 102 by sending the request over cellular signal 124, link internet/cellular infrastructure 106 and internet signal 104 and will receive the webpage in HTML over the same path. Webpage optimizer 202 will then perform the webpage optimization aspects of the invention described above and produce optimized XML and display widget which adapts the original webpage to the properties of (display, etc.) of smartphone 1006.

Also, for the case where webpage optimizer 202 is residing on tablet 1004, webpage optimizer 202 will make a request for a webpage from web server 102 by sending the request over cellular signal 124, link internet/cellular infrastructure 106 and internet signal 104 and will receive the webpage in HTML over the same path. Webpage optimizer 202 will then perform the webpage optimization aspects of the invention described above and produce optimized XML and display widget code which adapts the original webpage to the display properties and other properties of tablet 1004.

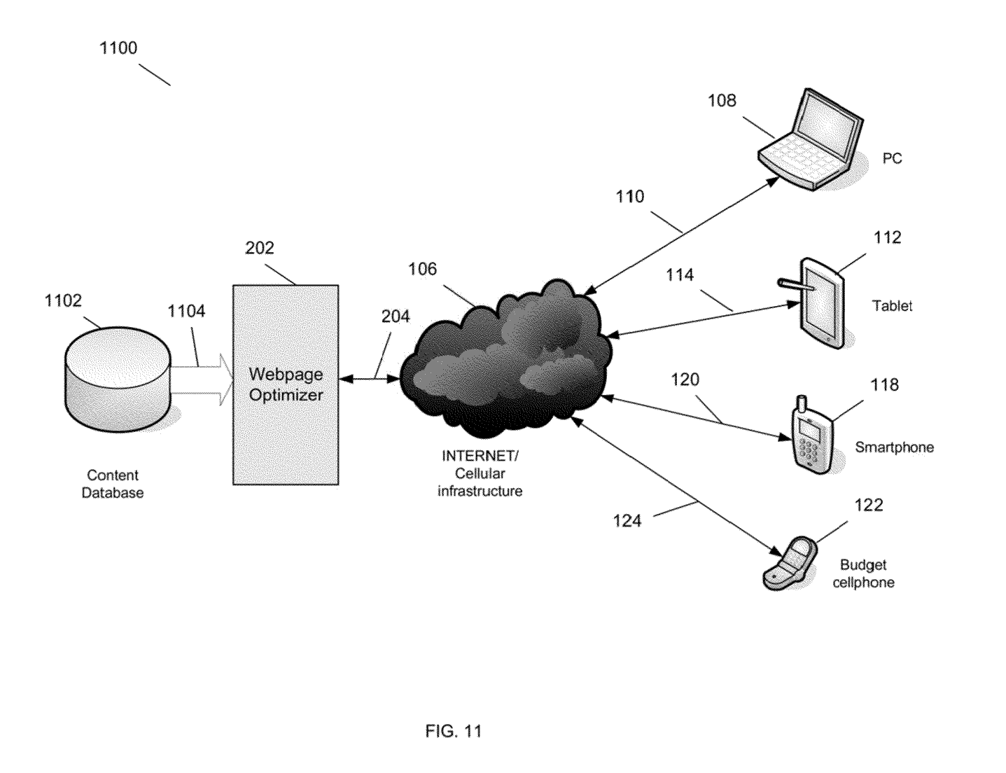

In another embodiment, webpages may be pushed to the webpage optimizer from a content database, rather than being fetched upon request. For example, a company may want to easily provide access to data from a database in the form of xml data to be accessed via a website. In this manner, the company may use a webpage optimizer in accordance with aspects of the present invention to pull data from a database to create a website. Once created, a user may then access the newly created website to view data from the database. This will be described in greater detail with reference to FIG. 11.

FIG. 11 shows system 1100 which illustrates an embodiment in which webpage optimization occurs without a request from the end user.

As shown in the figure, system 1100 is a modification of system 200 which has already been described. In the interests of brevity, the common elements of system 1100 and system 200 will not be described again.

In the figure, system 1100 includes an HTML database 1102 and elements of system 200 including web server 102, PC 108, tablet 112, smartphone 118 and budget cellphone 122 and webpage optimizer 202.

In the figure, HTML database 1102 is arranged to communicate with web server 102 via signal 1104.

HTML database 1102 contains PC webpages in HTML. In this embodiment, the webpage content is pushed over signal 1104 to webpage optimizer 202 for processing. In this embodiment, the code produced from the optimizing process may be further pushed to the end users over the internet or it may be stored at webpage optimizer 202 for later use on demand.

In another embodiment of the present invention, the use extends to database migration. There may be times when an institution may want to transfer data from one database to another database. This data transfer is called a database migration.

Many times, data that is stored in one database is stored in a manner that is inconsistent with the manner of storing data in another database. In such cases, the process of database migration is performed by manually programming a translation of the original data in the original database to data for storage in the subsequent database, which is complicated and resource consuming.

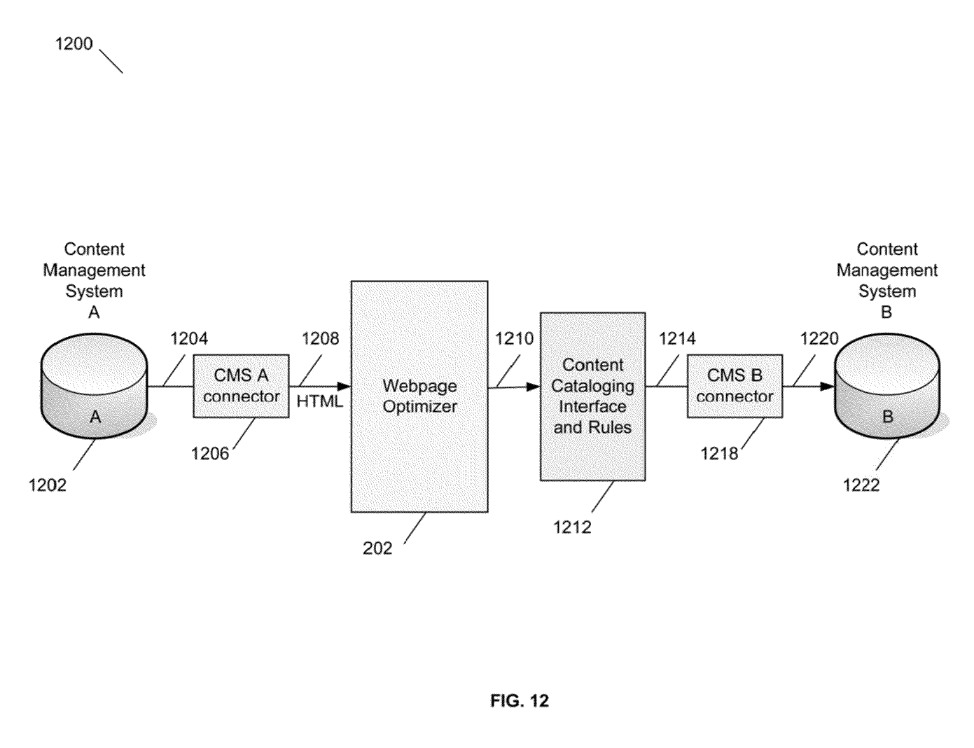

In accordance with the present invention, a webpage optimizer may be used to In particular, in an example embodiment, a webpage optimizer is used to restructure data from an original database. The restructured data may then be used to input the data into a second database. In this manner, the webpage optimizer may be used as a universal database migration tool. This aspect will now be described in greater detail with reference to FIG. 12.

FIG. 12 shows system 1200 which illustrates an embodiment in which one content database is migrated to another while simultaneously performing webpage optimization.

As shown in the figure, system 1200 includes a Content Management System A (CMS-A) 1202, a CMS-A connector 1206, webpage optimizer 202, a content cataloger 1212, a CMS-B connector 1218 and a CMS-B 1222.

In the figure, CMS-A 1202 is arranged to communicate with webpage optimizer 202 via a signal 1204, CMS-A connector 1206 and a signal 1208. Webpage optimizer 202 is arranged to communicate with Content Cataloger 1212 via a signal 1210. Content Cataloger 1212 is arranged to communicate with CMS-B 1222, via a signal 1214, CMS-B connector 1218 and signal 1220.

CMS-A 1202 is a database holding existing webpage content to be migrated to CMS-B 1222. CMS-A connector 1206 is a connector function performing interfacing between CMS-A 1202 and webpage optimizer 202. CMS-B connector 1218 is a connector function performing interfacing between webpage optimizer 202 and CMS-B 1222. Content Cataloger 1212 organizes the data for storage in CMS-B 1222.

CMS-A connector 1206 is familiar with the properties of CMS-A 1202 and the properties of webpage optimizer 202 and will perform any interfacing and conversion necessary on the content being migrated including conversion to HTML if required. CMS-B connector 1218 performs a similar function between CMS-B 1222 and webpage optimizer 202. As the migration of data between the databases occurs, webpage optimizer 202 optimizes the original content according to aspects of the present invention to produce new mobile-enabled content. Before storage in the new database (CMS-B 1222), content cataloger 1212 catalogs the mobile-enabled content to a custom set of cataloging rules determined by the CMS-B 1218 owner or user.

Another set of embodiments of the present invention extends to the use of search engines. Conventionally, when a user performs an internet search with a search engine based on a set of criteria, the search engine will output a list of “hits.” In particular, each hit corresponds to a link of a website, wherein some data of the website fell within the set of search criteria provided by the search engine. In some cases, a hit may include additional information, such as a string of characters describing the relevance of the website.

When a user activates one of the hits via a user interface on the user device, the user's user device will jump to the associated website.

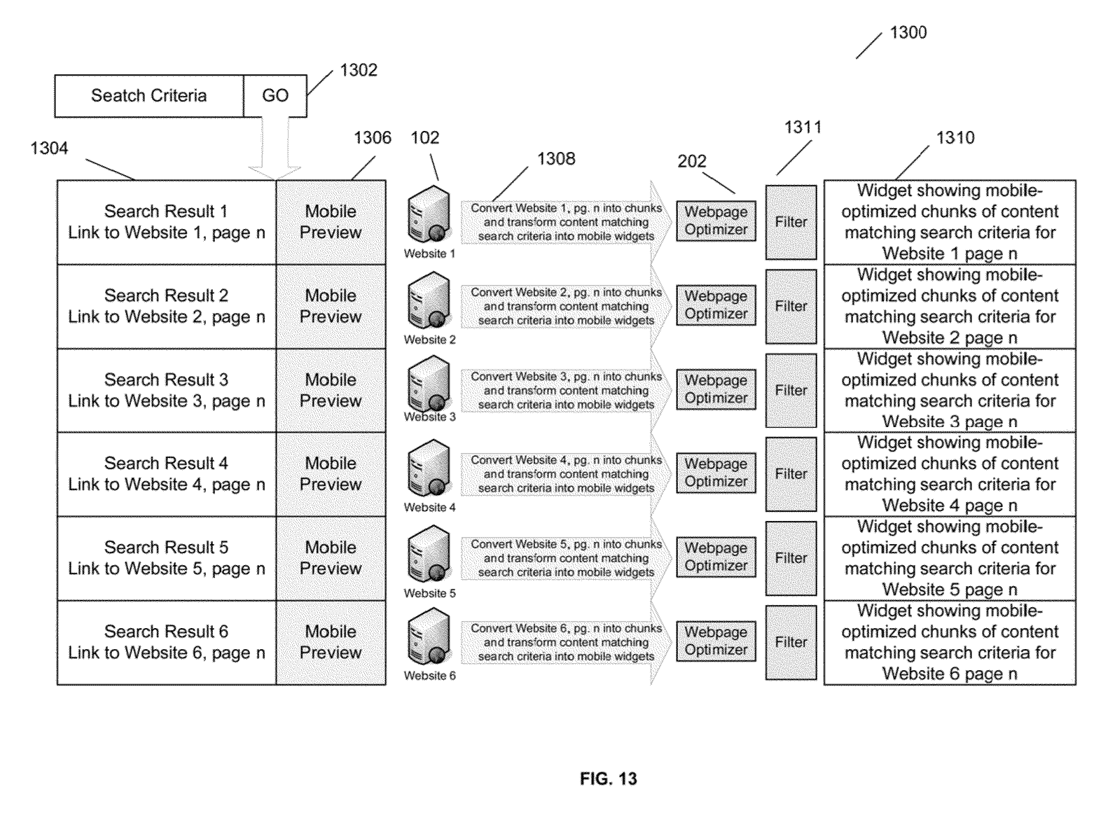

These embodiments are described with reference to FIG. 13.

FIG. 13 shows diagram 1300, which illustrates embodiments using webpage optimization on search lists produced by a conventional search engine.

As shown in the figure, diagram 1300 includes a search bar 1302, a search results column 1304, a mobile preview column 1306, a web server column 1307, a transformation column 1308, a webpage optimizer column 1309, a widget column 1310 and a filter column 1311.

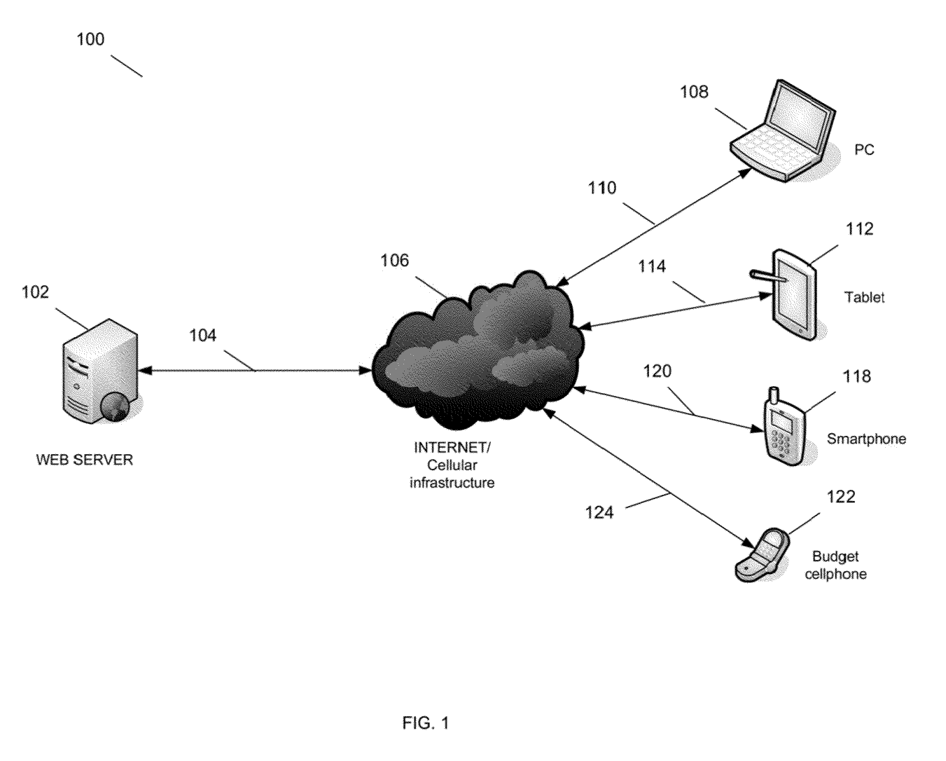

In the figure, search bar 1302 represents the bar containing search terms and search GO button of a conventional web search engine. Column 1304 is the list of search results produced by the search engine on initiation of a search. Column 1306 is produced in accordance with aspects of the present invention and is a list of mobile preview soft buttons related to and accompanying the search results in column 1304. Column 1307 represents the web servers on which the original PC-targeted webpages reside, wherein each one the equivalent of web server 102 of FIG. 1. Column 1308 forms a list of actions performed in accordance with the present invention. Column 1309 represents the webpage optimizer of this embodiment, which is the equivalent of webpage optimizer 202 of FIG. 2. Column 1310 is a list of widgets which are the results of the actions of column 1308. Column 1311 represents the filter which filters mobile-optimized widgets based on occurrence of searched keywords resulting in a relevant subset of widgets that can easily be viewed by the user, instead of going to the target website in the resultset.

On initiation of a search using the criteria entered, results are produced as line items in columns 1304. The search results column line items conventionally include the titles of the search results as hyperlinks to the listed websites. Each result is also accompanied by a mobile preview soft button as represented by the line items of column 1306. Selection of the mobile preview button causes the corresponding widget of column 1310 to display mobile-optimized content on the mobile user device. The mobile-optimized widget is a result of the actions taken in the corresponding line items of column 1308. The mobile-optimized widgets are a subset of widgets as identified by chunking process, limited based on occurrence of searched keywords column 1311 on that logical chunk.

In one embodiment of the set of embodiments represented in FIG. 13, the webpage optimization actions of column 1308 are performed on all the search results produced by the search engine.

In another embodiment of the set of embodiments represented in FIG. 13, the webpage optimization actions of column 1308 are performed on a predetermined and limited number of the search results produced by the search engine. This limits the webpage optimization processing required for the search, allowing the device to allocate more processing capacity to other types of processing.

In another embodiment of the set of embodiments represented in FIG. 13, the webpage optimization actions of column 1308 are performed only on the search results produced by the search engine that are displayed. In this embodiment, any webpage optimization processing for other results is deferred until action is taken by the user to scroll the other results into view. This minimizes the webpage optimization processing required for the search, allowing the device to allocate more processing capacity to other types of processing.

In previously described embodiments, webpage optimization according to aspects of the present invention exists as a commercial service offered to commercial webpage content providers. In another embodiment, aspects of the present invention can be used for personal webpage content. This is best described by a diagram.

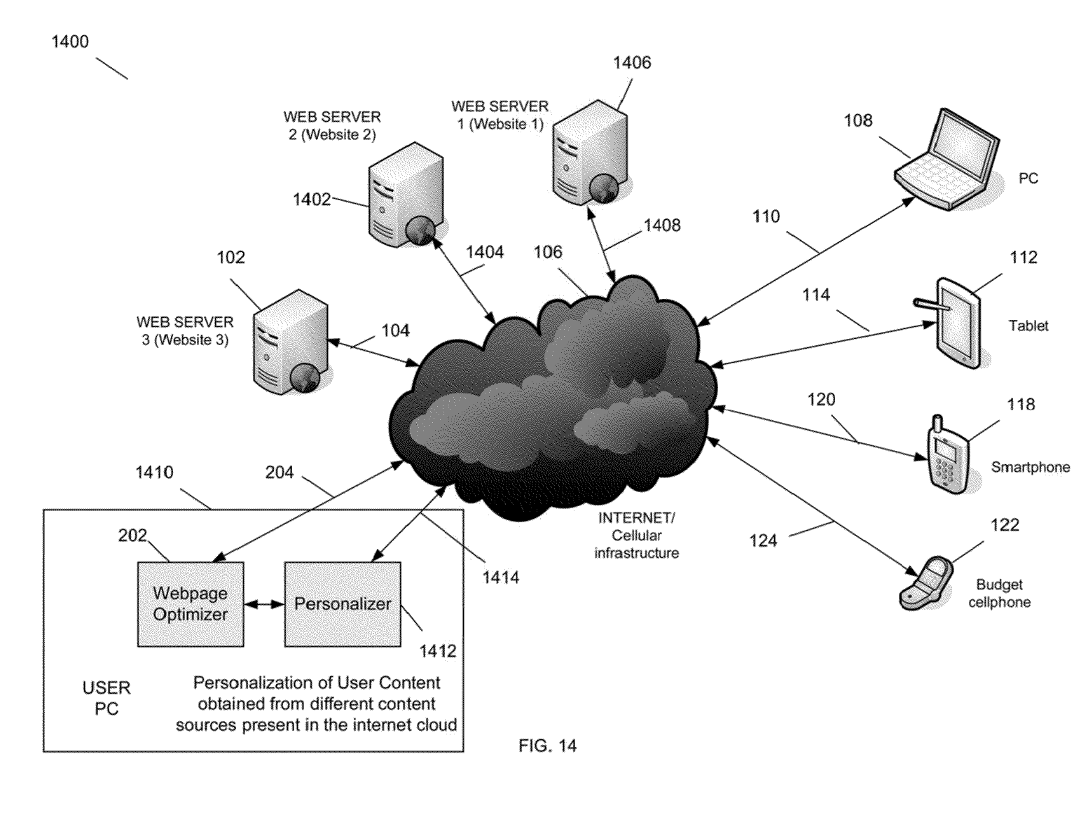

FIG. 14 shows a system 1400 where aspects of the present invention are used to manage personal web content.

In the figure, system 1400 includes web server 102, a webserver 1402, a web server 1406, internet and cellular infrastructure 106, PC 108, tablet 112, smartphone 118, budget cellphone 122, a user PC 1410 consisting of webpage optimizer 202 and a personalizer 1412.

As shown in the figure, web server 102 is arranged to access internet/cellular infrastructure 106 using internet signal 104, web server 1402 is arranged to access internet/cellular infrastructure 106 using an internet signal 1404, web server 1406 is arranged to access internet/cellular infrastructure 106 using an internet signal 1408. PC 108 is arranged to access internet/cellular infrastructure 106 using internet signal 110. Tablet 112 is arranged to access internet/cellular infrastructure 106 using internet signal 114. Smartphone 118 is arranged to connect to the internet/cellular infrastructure 106 using an internet signal 1404. Budget cellphone 122 is arranged to connect to the internet/cellular infrastructure 106 using internet signal 124. Webpage optimizer 202 is arranged to retrieve webpages from web server 102, webserver 1402 and web server 1406 via internet/cellular infrastructure 106 and internet signal 204. Personalizer 1412 is arranged to communicate with user devices over internet/cellular infrastructure 106 via internet signal 1414.

At user device 1410, personal web content is fetched from webservers 102, 1402 and 1406 by webpage optimizer 202 and the pages are optimized for various mobile devices such as tablet 112, smartphone 118 and budget cellphone 122. The webpage content can be personalized by personalizer 1412 as desired by the user and made available over the internet.

The aspects of the invention therefore are suitable for optimization of the personal webpage content of a private non-commercial user, including but not limited to social network page content, user generated content such as a blog and “favorite” content linked to on the personal webpage but existing on external websites. For such a purpose, in another embodiment, the webpage optimization and adaptation aspects of the present invention exist as an application or an app residing on any capable user devices such as, but not limited to, a PC, tablet or smartphone. This embodiment, therefore, allows an end user to experience the same unique advantages of the present invention as a commercial content provider through the optimization of existing personal webpage content to produce a mobile-optimized website.

As has been described above the unique aspects and processes of the invention circumvent many of the conventional problems associated with the display, search and navigation of webpage information on mobile devices for webpages intended for personal computers. Through its ability to sort through and discern the boundaries of content to produce results similar to a person, and in its ability to adapt to different end user devices and platforms, it is a vast improvement over conventional techniques to organize such content for mobile devices. In addition, through the flexibility of aspects of the invention in embodiment and utilization, it can very conveniently reside on different types of platform from servers to the end user device itself. It can also be used to enhance many implementations and invocations including but not limited to, content on demand, pushed content, search engine result enhancement, web content database migration, and for enterprise, consumer and personal applications.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. An apparatus, comprising:
a communication component operable to obtain content structures of a webpage;
an analyzing component operable to analyze a physical organization of the content structures and to analyze a navigational organization of the content structures;
a chunk identifying component operable to identify logical chunk clusters of the content structures, the logical chunk clusters corresponding to human-recognized sections of the webpage;
a table of contents component operable to generate a table of contents based on the identified logical chunk clusters; and
a code generating component operable to generate a file having stored therein logical chunk metadata information for each identified logical chunk cluster, respectively, listed in the table of contents,
wherein the table of contents includes an entry for each identified logical chunk cluster, respectively.

2. The apparatus of claim 1,
wherein said chunk identifying component is further operable to finalize a boundary for each identified logical chunk cluster, based on a set of parameters to increase or decrease a scope of each logical chunk boundary, respectively, through aggregation or sub-chunking,
wherein said chunk identifying component is further operable to identify a header, rich media, body items and a footer for each identified logical chunk cluster,
wherein said table of contents component includes a linking component operable to link each identified logical chunk cluster to a respective header,
wherein each header acts as an index into the table of contents, and
wherein each logical chunk may be retrieved via a respective header without retrieving of the entire webpage.

3. The apparatus of claim 1, wherein said analyzing component is operable to analyze the content structures and navigational structure based on at least one of the group consisting of a number of pages to process, parallel page crawling threads, a minimum standalone coverage for navigation qualification, a minimum cluster coverage for navigation qualification, a minimum threshold for merging by similarity of targets, a minimum threshold for merging by inclusion of targets, a minimum merging by inclusion ratio of targets, a maximum navigation groups per page, a minimum target count, a maximum target count, a maximum number of words outside of a navigation ratio, a minimum number of words in a navigation, a maximum number of targets with many words ratio, a minimum long word length, a maximum targets with many short words ratio, a minimum navigation group leaf count, non-local targets and skipped targets, and combinations thereof.

4. The apparatus of claim 1, wherein said analyzing component is operable to analyze the physical organization and logical chunk structures based on at least one of the group consisting of a maximum number of references in a chunk, a maximum number of words per item in structurally repeating groups, a minimum article type chunk size, a minimum article type chunk density, a minimum article type chunk rate of density increase, a minimum structurally repeating body item similarity score, a minimum artificial chunk size, a minimum artificial chunk density, and combinations thereof.

5. The apparatus of claim 1,
wherein said communication component is further operable to receive a request from a device to view the webpage,
wherein the request includes information related to the display capabilities of the device,
wherein said code generating component is further operable to transform the identified logical chunk clusters into a new physical organization and a content display widget based on at least one of the group consisting of a physical dimension of the device, a computing power of the device, resources of the device and combinations thereof, and
wherein said code generating component is further operable to create contextual widgets operable to adapt their behavior based on the presence of other types of widgets based on the device.

6. The apparatus of claim 1,
wherein said communication component is operable to obtain database content structures of a content residing inside a source web management database,
wherein said analyzing component is further operable to analyze a physical organization of the database content structures,
wherein said analyzing component is further operable to analyze a navigational organization of the database content structures;
wherein said chunk identifying component is further operable to identify database logical chunk clusters of the database content structures, the database logical chunk clusters corresponding to human-recognized sections of the content,
wherein said table of contents component is further operable to generate a database table of contents based on the identified database logical chunk clusters, and
wherein said code generating component is further operable to generate a file having stored therein database logical chunk metadata information for each identified database logical chunk cluster, respectively, listed in the database table of contents,
wherein the database table of contents includes an entry for each identified database logical chunk cluster, respectively.

7. The apparatus of claim 6,
wherein said communication component comprises a connector component operable to load the content of logical chunk into a target web content management system database, and
wherein said code generating component is further operable to transform the identified logical chunk clusters into a new physical organization and a content display widget and to load the new physical organization and the content display widget into the target web content management system database.

8. The apparatus of claim 1,
wherein said communication component is further operable to generate a list of a first webpage and a second webpage based on a search criteria,
wherein said communication component is operable to obtain data structures of a webpage by obtaining first data structures of the first webpage and by obtaining second data structures of the second webpage,
wherein said analyzing component is operable to analyze the structure of data structures by analyzing structure of the first data structures and by analyzing the structure of the second data structures,
wherein said chunk identifying component is operable to identify logical chunk clusters of the data structures by identifying first logical chunk clusters of the first data structures and by identifying second logical chunk clusters of the second data structures,
wherein said table of contents component is operable to generate a table of contents based on the identified logical chunk clusters by generating a first table of contents based on the identified first logical chunk clusters and by generating a second table of contents based on the identified second logical chunk clusters,
wherein said code generating component is operable to generate new data structures based on the table of contents by generating new first data structures based on the first table of contents and by generating new second data structures based on the second table of contents,
wherein the first table of contents includes an entry for each identified first logical chunk cluster, respectively, and
wherein the second table of contents includes an entry for each identified second logical chunk cluster, respectively.

9. The apparatus of claim 1,
wherein said communication component is further operable to obtain second content from a second source,
wherein said code generating component is further operable to generate the file as a home page for an end user, and
wherein the second source comprises one of the group consisting of a social media website account and a database.

10. A method, comprising:
obtaining, via a communication component, content structures of a webpage;
analyzing, via an analyzing component, a physical organization of the content structures;
analyzing, via the analyzing component, a navigational organization of the content structures;
identifying, via a chunk identifying component, logical chunk clusters of the content structures, the logical chunk clusters corresponding to human-recognized sections of the webpage;
generating, via a table of contents component operable, a table of contents based on the identified logical chunk clusters; and
generating, via a code generating component, a file having stored therein logical chunk metadata information for each identified logical chunk cluster, respectively, listed in the table of contents,
wherein the table of contents includes an entry for each identified logical chunk cluster, respectively.

11. The method of claim 10, further comprising:
finalizing, via the chunk identifying component, a boundary for each identified logical chunk cluster, based on a set of parameters to increase or decrease a scope of each logical chunk boundary, respectively, through aggregation or sub-chunking; and
identifying, via the chunk identifying component, a header, rich media, body items and a footer for each identified logical chunk cluster,
wherein the table of contents component includes a linking component operable to link each identified logical chunk cluster to a respective header,
wherein each header acts as an index into the table of contents, and
wherein each logical chunk may be retrieved via a respective header without retrieving of the entire webpage.

12. The method of claim 10, wherein said the content structures and navigational structures comprises analyzing based on at least one of the group consisting of a number of pages to process, parallel page crawling threads, a minimum standalone coverage for navigation qualification, a minimum cluster coverage for navigation qualification, a minimum threshold for merging by similarity of targets, a minimum threshold for merging by inclusion of targets, a minimum merging by inclusion ratio of targets, a maximum navigation groups per page, a minimum target count, a maximum target count, a maximum number of words outside of a navigation ratio, a minimum number of words in a navigation, a maximum number of targets with many words ratio, a minimum long word length, a maximum targets with many short words ratio, a minimum navigation group leaf count, non-local targets and skipped targets, and combinations thereof.

13. The method of claim 10, wherein said analyzing the physical organization and logical chunk structures comprises analyzing based on at least one of the group consisting of a maximum number of references in a chunk, a maximum number of words per item in structurally repeating groups, a minimum article type chunk size, a minimum article type chunk density, a minimum article type chunk rate of density increase, a minimum structurally repeating body item similarity score, a minimum artificial chunk size, a minimum artificial chunk density, and combinations thereof.

14. The method of claim 10, further comprising:
receiving, via the communication component, a request from a device to view the webpage;
transforming, via the code generating component, the identified logical chunk clusters into a new physical organization and a content display widget based on at least one of the group consisting of a physical dimension of the device, a computing power of the device, resources of the device and combinations thereof; and
creating, via the code generating component, contextual widgets operable to adapt their behavior based on the presence of other types of widgets based on the device,
wherein the request includes information related to the display capabilities of the device.

15. The method of claim 10,
obtaining, via the communication component, database content structures of a content residing inside a source web management database;
analyzing, via the analyzing component, a physical organization of the database content structures;
analyzing, via the analyzing component, a navigational organization of the database content structures;
identifying, via the chunk identifying component, is further operable to identify database logical chunk clusters of the database content structures, the database logical chunk clusters corresponding to human-recognized sections of the content;
generating, via the table of contents component, a database table of contents based on the identified database logical chunk clusters; and
generating, via the code generating component, a file having stored therein database logical chunk metadata information for each identified database logical chunk cluster, respectively, listed in the database table of contents,
wherein the database table of contents includes an entry for each identified database logical chunk cluster, respectively.

16. The method of claim 15, further comprising:
loading, via a connector component within the communication component, the content of logical chunk into a target web content management system database;
transforming, via the code generating component, the identified logical chunk clusters into a new physical organization and a content display widget; and
loading, via the code generating component, the new physical organization and the content display widget into the target web content management system database.

17. The method of claim 10, further comprising:
generating, via the communication component, a list of a first webpage and a second webpage based on a search criteria;
obtaining, via the communication component, data structures of a webpage by obtaining first data structures of the first webpage and by obtaining second data structures of the second webpage;
analyzing, via the analyzing component, the structure of data structures by analyzing structure of the first data structures and by analyzing the structure of the second data structures;
identifying, via the chunk identifying component, logical chunk clusters of the data structures by identifying first logical chunk clusters of the first data structures and by identifying second logical chunk clusters of the second data structures;
generating, via the table of contents component, a table of contents based on the identified logical chunk clusters by generating a first table of contents based on the identified first logical chunk clusters and by generating a second table of contents based on the identified second logical chunk clusters; and
generating, via the code generating component, new data structures based on the table of contents by generating new first data structures based on the first table of contents and by generating new second data structures based on the second table of contents,
wherein the first table of contents includes an entry for each identified first logical chunk cluster, respectively, and
wherein the second table of contents includes an entry for each identified second logical chunk cluster, respectively.

18. The method of claim 10, further comprising:
obtaining, via the communication component, second content from a second source; and
generating, via the code generating component, the file as a home page for an end user,
wherein the second source comprises one of the group consisting of a social media website account and a database.
